(19) United States
(12) Patent Application Publication
(10) Pub. No.: US 2007/0186870 A1
(43) Pub. Date: Aug. 16, 2007

(54) WIRELESS CONFINEMENT AND TRAINING SYSTEM FOR AN ANIMAL

(76) Inventor: Michael Westrick, Fort Wayne, IN (US)

Correspondence Address: TAYLOR & AUST, P.C., 142 SOUTH MAIN STREET, P. O. BOX 560, AVILLA, IN, 46710, US

(21) Appl. No.: 11/626,711

(22) Filed: Jan. 24, 2007

Related U.S. Application Data
(60) Provisional application No. 60/761,705, filed on Jan. 24, 2006.

(51) Int. Cl. A01K 15/04

(52) U.S. Cl. 119/721

(57) ABSTRACT

A confinement system including a plurality of receiver/transmitters spaced along a border and a behavior modification device. The behavior modification device includes a receiver and a stimulus device. The receiver receives a signal from at least one of the plurality of receiver/transmitters. The stimulus device delivers a stimulus if the major modification device is within a predetermined distance of the border.

### CROSS REFERENCE TO RELATED APPLICATIONS

This is a non-provisional application based upon U.S. provisional patent application Ser. No. 60/761,705, entitled “ELECTRONIC PET CONFINEMENT SYSTEM”, filed Jan. 24, 2006.

### BACKGROUND OF THE INVENTION

1. Field of the Invention

The present invention relates to an animal confinement system, and, more particularly, to a wireless confinement system for an animal.

2. Description of the Related Art

Pet confinement systems often include a radio frequency transmitter having a wire loop for transmitting the radio frequency signal, as illustrated in FIG. 1. The wire loop antenna roughly defines the boundary to which the animal is to be confined. The animal wears a receiving unit that is attached to a collar worn around the animal's neck. The animal gets within a predetermined distance of the wire loop antenna, the receiver unit detects the radio frequency signal transmitted from the loop antenna, where upon a correcting stimulus, such as an electrical shock is applied to the animal. A problem with this type of system is that it is difficult and time consuming to install and maintain the underground loop antenna. If a discontinuity in the wire loop antenna occurs it is necessary to locate and repair the discontinuity. Additionally, once the wire loop antenna is laid into the ground, the boundaries of the animal's confinement area are fixed and cannot be easily modified. Often the cost of installation is several times the actual hardware cost for the system itself.

It is also known to have a wireless pet confinement system using a centrally located transmitter, such as illustrated in FIG. 2. This generally defines a circular area for the pet and has a limited range for a confinement area. A problem with this system is that it inconsistently defines the boundary, which can shift due to atmospheric variation as well as the location of large metal objects inside the perimeter, such as vehicles, bicycles, lawn mowers, etc., that can alter the propagation characteristics of the signal.

What is needed in the art is a wireless animal confinement system that has an easily established boundary.

### SUMMARY OF THE INVENTION

The present invention provides a wireless animal confinement method and system, which allows for the easy establishment of a boundary.

The invention, in one form, is directed to a confinement system including a plurality of receiver/transmitters spaced along a border and a behavior modification device. The behavior modification device includes a receiver and a stimulus device. The receiver receives a signal from at least one of the plurality of receiver/transmitters. The stimulus device delivers a stimulus if the major modification device is within a predetermined distance of the border.

An advantage of the present invention is that since a wire loop antenna is not needed, a system can be more easily set up and relocated if the need arises.

Another advantage of the present invention is that the boundary transmitters are activated only when the receiver unit on the collar interrogates the transponders.

Yet another advantage of the present invention is that the receiver can determine the validity of the border signal.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematical illustration of a prior art pet confinement system;

FIG. 2 is a schematical representation of another prior art pet confinement system;

FIG. 3 is a schematical illustration of one embodiment of a wireless animal confinement system of the present invention;

FIG. 4 is a schematical illustration of a border established by transponders of the pet confinement system of FIG. 3;

FIG. 5 illustrates elements of a collar of the pet confinement system of FIG. 3;

FIG. 6 is a perspective view of an embodiment of a transponder used in the animal confinement system of FIGS. 3 and 4; and

FIG. 7 is a schematical illustration of elements of a receiver unit and a transponder unit of FIGS. 5 and 6.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

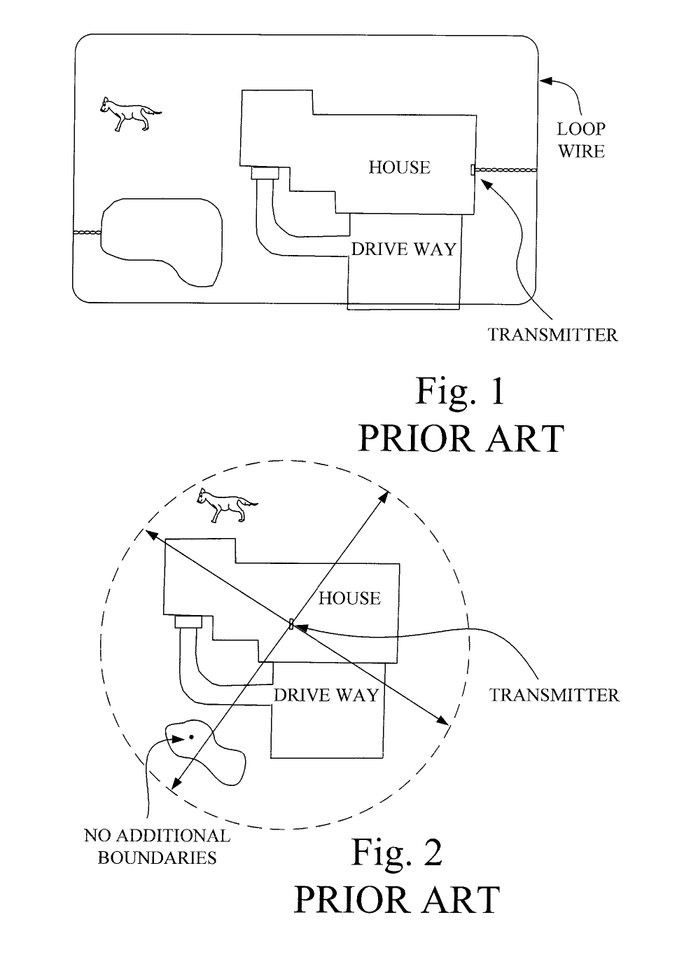

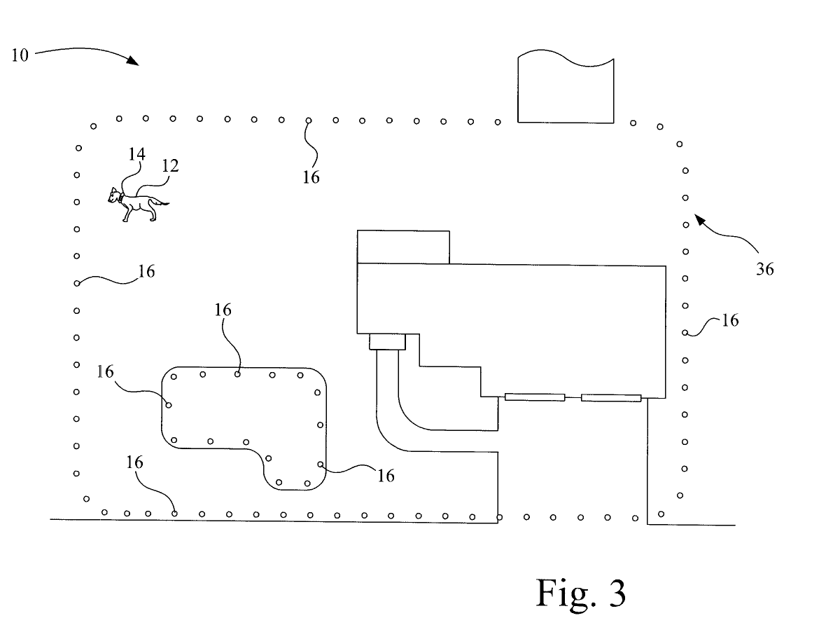

Referring now to the drawings, and more particularly to FIG. 3, there is shown a confinement system 10 for an animal 12 having a behavior modification device 14, also known as a collar system 14 around the neck of animal 12. Multiple receiver/transmitters 16, also known as transponders 16, are spaced about a border 36. Transponders 16 are placed approximately a predetermined distance apart along border 36, the predetermined distance may be, for example, 5 feet, or 7 feet. Transponders 16 are shaped similar to a golf tee and are simply pressed into the ground. Border 36 is established by placing transponders 16 in a spaced apart manner substantially into the ground or even under the ground level. If border 36 includes installing transponders 16 across a concreted or paved area, holes are simply drilled into the concrete or asphalt with transponder 16 being placed therein and the hole filled with silicone calking. Unlike prior art units such as those illustrated in FIGS. 1 and 2, the present invention allows for the easy establishment of a border up to an existing building or other natural barrier without preventing animal 12 from being in contact with a natural barrier or being able to enter a building. For example, as shown in FIG. 3, an out building has been shown that forms part of a natural barrier with there being no requirement to continue the border in front of the building. If a door is available on the side of the building facing the containment area, then the animal can simply enter the building. As can be see in FIGS. 1 and 2, the prior art systems present a problem for the installer to utilize such natural barriers.

Transponders 16 may be passive or micro-powered devices requiring either no battery or a sealed permanent micro-lithium battery that may provide numerous years of continuous operation. Besides the ease of installation, transponders 16 may be located and moved to a new location by simply unearthing each transponder 16 and placing them in a new position.

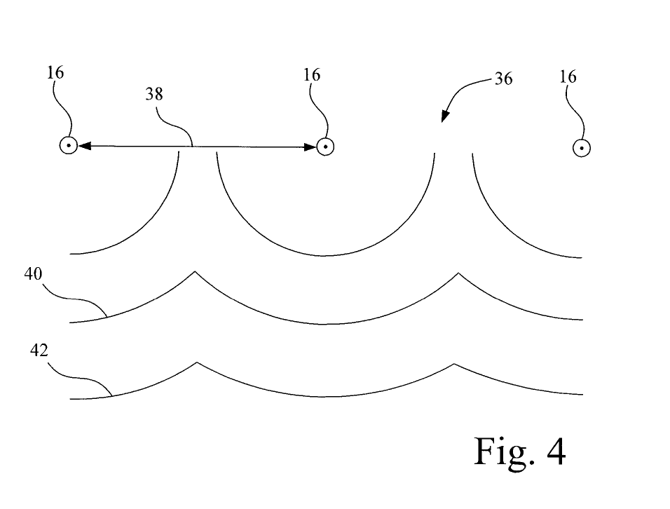

Now, additionally referring to FIG. 4, border 36 is illustrated having lines showing signal strength of positions of transponder 16, which is utilized by collar system 14 to establish the boundary. Transponders 16 are located a distance 38 apart, which for the purposes of discussion will be assumed to be seven feet. The first distance 40 from border 36 establishes a warning level that can be utilized in collar system 14 to warn the animal that it is approaching border 36. Second distance 42 is closer than distance 40 and it is at this distance that stimulation, such as an electrical shock would be applied to animal 12.

Collars system 14, which is worn by animal 12, transmits a low power interrogation signal or looks for a transmitter signal when an internal motion detector senses movement of animal 12. When collar system 14 reaches distance 40 from border 36, which is determined by an amplitude measurement of the reply or transmitted signal from transponder 16, an audible warning is produced by collar system 14 to warn animal 12 of its approach to border 36. As animal 12 approaches distance 42, a further variable stimulus is applied to animal 12. The presence of multiple transponders 16 along border 36 provides an averaging affect to increase the accuracy of the predetermined distances as can be seen in the shape of the lines at distances 40 and 42 from border 36.

The installation of multiple transponders 16 spaced, for example 5 feet apart, require that an installation kit include numerous transponders 16. For example, a half-acre square lot has a perimeter of approximately 590 feet; if distance 38 is set at 5 feet then 118 transponders 16 will be required for installation.

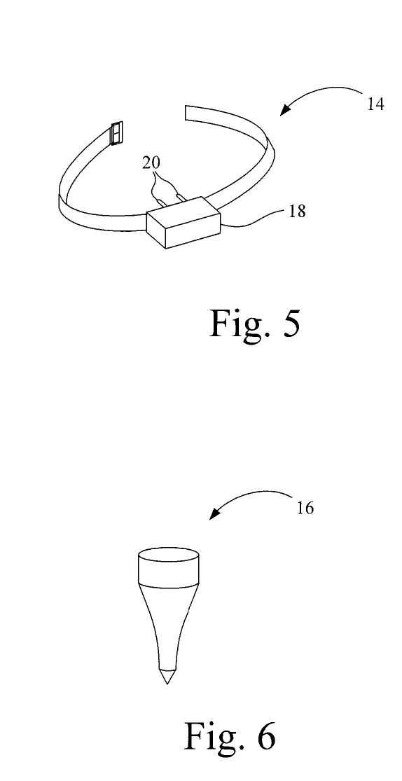

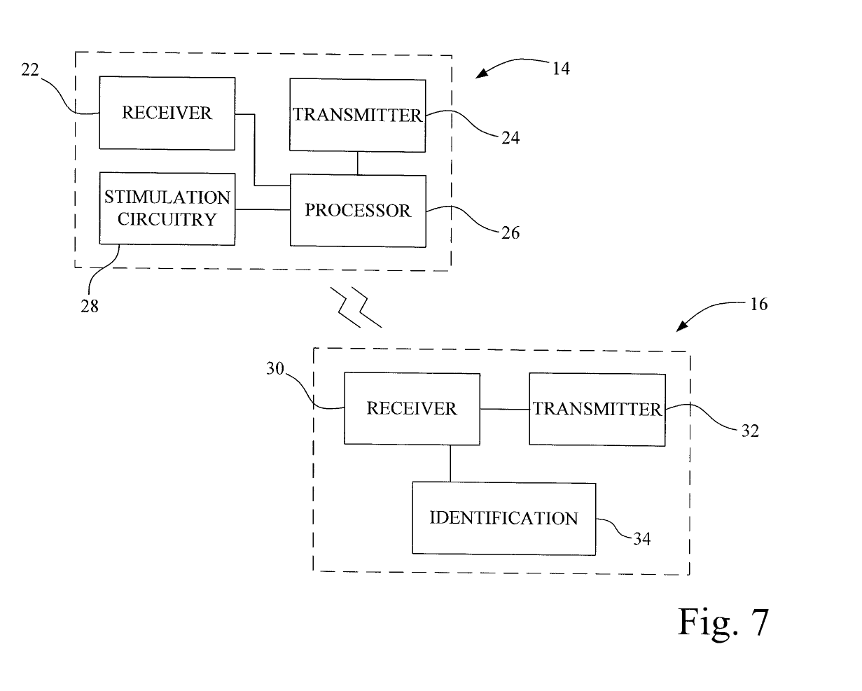

Now, additionally referring to FIGS. 5-7, collar system 14 is shown to include a housing 18 having electrodes 20 and containing a receiver 22, a transmitter 24, a processor 26 and stimulation circuitry 28. Transponders 16 include a transmitter 30, a receiver 32 and an identification 34. Transmitter 30, receiver 32 and identification 34 may be understood to be a radio frequency ID device (RFID), which sends an identification signal when it receives an interrogation signal from a transmitter, such as transmitter 24.

Processor 26 wakes up and processes a signal indicating that animal 12 has caused collar system 14 to be moved, this signal can be produced by a vibration sensor or an accelerometer sensor, not illustrated. Processor 26 then comes out of a sleep mode and causes transmitter 24 to send an interrogation signal to determine if any transponders 16 are within range. If a transponder 16 is in range and receives the interrogation signal, it responds to the signal transmitted by transmitter 24 and sends a signal back to receiver 22. Receiver 22 receives a signal from transponder 16 and determines the strength of the signal therefrom. The strength of the signal from transponder 16 determines the distance from border 36, to then determine if distance 40 or 42 have been breached. If animal 12 is located between distance 40 and distance 42 then an audible warning is issued by collar system 14. If animal 12 proceeds and is less than or equal to distance 42 then processor 26 activates stimulation circuitry 28 to provide an electrical stimulus to animal 12.

When animal 12 is away from border 36, such that no information is being received from any transponder 16 and no movement by animal 12 is detected by collar system 14, which continues for a predetermined amount of time, then processor 26 shuts down transmitter 24 and processor 26 goes into a sleep mode.

Receiver 32 receives an interrogation signal from transmitter 24, which causes transmitter 30 to send an identification 34 in response. Transponder 16 may include identical identification information 34 for each of transponders 16 for a particular confinement system 10. Another confinement system 10 may have a different identification 34, which processor 26 may be programmed to ignore. This advantageously prevents adjoining systems from interfering and precludes an irate neighbor from redefining a border by installing, in a serendipitous manner, other transponders 16 in an attempt to define a different border. Further, identification 34 may be unique for each transponder 16 and processor 26 may accept a predetermined range of identifications to which it will respond. This advantageously prevents compromising of the system by the neighbor or vandals that may place transponders 16 in the confinement area, which may be done by simply throwing them there. This also precludes thieves from simply buying and carrying a generic transponder and entering the area to discourage a guard dog from approaching them.

Confinement system 10 modifies the behavior of an animal by placing electrodes 20 in contact with animal 12, which are utilized to when predetermined distances from border 36 are breached. Border 36 is established by placing transponders 16 in a spaced manner along border 36. The interrogation of transponder 16 by collar system 14 provides the information necessary for collar system 14 to issue a warning or a stimulus based upon the position and direction of movement of the animal, which may be determined by changes in signal strength received by collar system 14 from transponders 16 as animal 12 approaches or moves from border 36.

The ease of installation of confinement system 10 along with its flexibility provides new options for the pet owner and even allows the defining of multiple areas for pets that can be in an overlapping configuration. For example, a border can be established having one ID configuration and an inner boundary within that boundary can be established with another set of transponders having a second identification 34. One animal can be provided with a collar system responsive only to the first set of identifications and a second animal can be provided with a collar that is responsive to both sets of identifications, thereby confining the second animal to a more restricted area than the first animal.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A confinement system, comprising:
a plurality of receiver/transmitters spaced along a border; and
a behavior modification device including:
a receiver to receive a signal from at least one of said plurality of receiver/transmitters; and
a stimulus device to deliver a stimulus if said behavior modification device is within a predetermined distance of said border.

2. The confinement system of claim 1 wherein said receiver/transmitters are transponders.

3. The confinement system of claim 2, wherein a substantial portion of each of said plurality of transponders is substantially below ground level.

4. The confinement system of claim 2, wherein each of said plurality of transponders is below ground level.

5. The confinement system of claim 2, wherein each of said plurality of transponders are spaced approximately a predetermined distance from an adjacent one of said plurality of transponders.

6. The confinement system of claim 2, wherein each of said plurality of transponders include a radio frequency identification (RFID) device.

7. The confinement system of claim 6, wherein each of said RFID devices have a selected identification that is sent to said receiver when said transponder is interrogated by said receiver.

8. The confinement system of claim 7, wherein said receiver is responsive to a selected set of identifications from said RFID devices.

9. An animal confinement system, comprising:
a plurality of transponders spaced along a border; and
a behavior modification device including:
a housing;
a collar connected to said housing, said collar positioned about a portion of the animal;
a transmitter at least partially contained in said housing, said transmitter configured to send a signal to said plurality of transponders;
a receiver at least partially contained in said housing, said receiver being receptive to a signal from at least one of said plurality of transponders; and
a stimulus device to deliver a stimulus to the animal dependant upon said signal from at least one of said plurality of transponders.

10. The confinement system of claim 9, wherein a substantial portion of each of said plurality of transponders is substantially below ground level.

11. The confinement system of claim 9, wherein each of said plurality of transponders is below ground level.

12. The confinement system of claim 9, wherein each of said plurality of transponders are spaced approximately a predetermined distance from an adjacent one of said plurality of transponders.

13. The confinement system of claim 9, wherein each of said plurality of transponders include a radio frequency identification (RFID) device.

14. The confinement system of claim 13, wherein each of said RFID devices have a selected identification that is sent to said receiver when said transponder is interrogated by said receiver.

15. The confinement system of claim 14, wherein said receiver is responsive to a selected set of identifications from said RFID devices.

16. A method of modifying the behavior of an animal, comprising the steps of:
placing a stimulation device in contact with the animal;
establishing a border with a plurality of transponders;
interrogating at least one of said plurality of transponders; and
applying a stimulation to the animal by way of said stimulation device dependant on a signal from at least one of said plurality of transponders.

17. The method of claim 16, wherein said interrogating step is not carried out unless movement of the animal is detected.

18. The method of claim 17, wherein said applying step further includes issuing a warning tone when said stimulation device is a first predetermined distance from said border.

19. The method of claim 18, wherein said stimulation is applied when said stimulation device is a second predetermined distance from said border, said second predetermined distance being less than said first predetermined distance.

20. The method of claim 16, wherein said plurality of transponders are positioned along said border approximately a predetermined distance from each adjacent one of said plurality of transponders.
